(19) United States
(12) Patent Application Publication
(10) Pub. No.: US 2007/0033030 A1
(43) Pub. Date: Feb. 8, 2007

(54) Techniques for measurement, adaptation, and setup of an audio communication system

(76) Inventor: Oded Gottesman, (US)

Correspondence Address: ODED GOTTESMAN, 1055 TISHA COURT, SANTA BARBARA, CA, 93111, US

(21) Appl. No.: 11/489,267

(22) Filed: Jul. 18, 2006

Related U.S. Application Data
(60) Provisional application No. 60/702,515, filed on Jul. 19, 2005.

(51) Int. Cl. G10L 15/20

(52) U.S. Cl. 704/233

(57) ABSTRACT

Methods and systems for providing automated measurement, adaptation and setup of voice communication system using one or more reference signals. An audio device is automatically configured at or near commencement of establishment of a communications path, such that the configuration is performed in a minimally humanly discernible manner. The methods comprise transmitting one or more predetermined reference signals into an acoustic environment, receiving the transmitted signals from the acoustic environment to thereby provide received signals, and adjusting at least one of a speaker gain and a microphone gain in response to the received signals. Adjustment of audio circuits, such as amplifiers, may be performed based on a signal analysis of the received signals. Optionally, computing parameters and/or generating signals may be performed based on the signal analysis, and the computed parameters may be inputted to auxiliary systems such as audio enhancement, voice activity detector, speech coding and/or speech recognition systems. Computed parameters may be representative of background noise, delay between a generated audible signal and a corresponding input signal captured by a microphone, signal level, gain, energy, and other parameters that may be useful for subsequent audio recording, storage, enhancement, coding, or recognition system.

This application claims priority to my Provisional Patent Application Ser. No. 60/702,515 filed on Jul. 19, 2005 and all the benefits accruing therefrom under 35 USC § 119, the entire contents of which are incorporated herein by reference.

### NOTICE OF MATERIAL SUBJECT TO COPYRIGHT PROTECTION

Material in this patent document may be subject to copyright protection under the copyright laws of the United States and other countries. The owner of the copyright has no right to exclude facsimile reproduction of the patent specification as it appears in files or records which are available to members of the general public from the United States Patent and Trademark Office, but the owner otherwise reserves any and all copyright rights therein.

### BACKGROUND OF THE INVENTION

1. Field of the Invention

The invention relates generally to methods and systems for processing audio and, more specifically, to methods and systems for estimating one or more parameters of an audio communications path using transmitted audio information that is minimally discernable to a human, wherein the estimated parameters are used to improve audio quality.

2. Description of Prior Art

Existing voice communication devices are available in many different forms and configurations. These devices use various networks and protocols, and may be integrated into general purpose instruments that provide diverse functionalities, including telephony as well as a myriad of other audio and non-audio applications. In many cases, these devices are not specifically tailored to meet existing telephony standards. Moreover, these devices are oftentimes employed in unpredictable acoustical environments, such that the device may not be configured to deliver acceptable voice communication in a real-world setting. Shortcomings such as distortion, non linearities, background noise, and echo may be observed. In addition, performance of associated auxiliary systems such as voice activity detectors, adaptive gain controllers, and speech recognition systems may not achieve adequate performance. As a result, such devices are not accepted by the general public as achieving voice quality that is comparable to that of conventional landline telephones. In particular, PC-based voice over Internet Protocol (VoIP) terminals, chat applications, some hand-free telephony systems, and multi-purpose “smart” headsets oftentimes suffer audio distortions such as echo, non-linearity, and noise. In such devices and conditions, audio processing systems that are commonly used in voice communication terminals, such as acoustic echo cancellers (AECs), fail to achieve acceptable performance and often have annoying adaptation artifacts due to their inferior audio setup, and operation in random or less than optimal conditions.

In view of the foregoing shortcomings, what is needed is a technique for configuring an audio device of a communication terminal in a manner so as to improve audio quality in any of a variety of acoustic environments.

### SUMMARY OF THE INVENTION

Pursuant to one aspect of the invention, an audio device is automatically configured upon commencement of establishment of a communications path, such that the configuration is performed in a minimally humanly discernible manner. Illustratively, configuration is performed by transmitting one or more predetermined reference signals into an acoustic environment, receiving the transmitted signals from the acoustic environment, and adjusting at least one of a speaker gain and a microphone gain. Illustratively, the reference signals include a ring tone signal as used in landline telephony systems.

Another aspect of the present invention is to compute one or more parameters useful for subsequent audio processing or systems, such as a delay between an acoustical signal generated by a speaker in response to an electrical signal being input to the speaker, and an electrical signal produced by a microphone in response to the acoustical input being received from the speaker.

Another aspect of the invention is to improve performance of subsequent audio processing systems by extracting one or more parameters of the audio environment upon a communications path being established, and in a way that is minimally perceived by a user, illustratively achieved by performing underlying processing while transmitting at least one reference signal that is used in conjunction with landline telephony, such as ring tone, dual tone multifrequency (DTMF) tones, or the like.

Pursuant to another aspect of the invention, systems and methods are provided to improve communication audio quality in a way that is efficient, universal and yet substantially audibly imperceptible (or at least not annoying) to a user. The system analyzes a communication terminal's audio configuration such as a speaker gain, a microphone gain, or an amplifier gain, to thereby extract one or more audio parameters, and/or to adjust the communication terminal's audio configuration. This configuration is adjusted upon commencement of establishment of a communications path so as to improve a subsequent voice call. The system performs some or all the followings: (a) synthesis of one or more predetermined reference signals, (b) transmitting an output audible signal, (c) inputting an audible signal, (d) analysis of one or more signals such as speech, noise, or tones such as dual-tone multi-frequency (DTMF), (e) adjustment of audio circuits such as amplifiers based on a signal analysis, (f) computing parameters and/or generating signals that are based on the signal analysis, and (g) inputting such parameters to one or more auxiliary systems such as audio enhancement, voice activity detector, speech coding and/or speech recognition. Such computed parameters may be representative of the background noise, the delay between the generated audible signal and the corresponding input signal captured by a microphone, signal gain or energy, and other parameters that may be useful for subsequent audio enhancement, coding, and/or recognition systems.

Illustratively, the present invention can be embedded in or form part of an existing device such as telephone, wireless phone, voice-over-Internet protocol (VoIP) phone or other communication device or software, computer, laptop or pocket personal computer (PC), personal digital assistant (PDA), teleconferencing system, and/or multi-purpose “smart” headset. It can, but need not, also share some of the device's resources or components, such as speaker, microphone, handset, tone detector, tone generator, speech recognizer, speech synthesizer, channel interface, user interface, memory, and/or signaling system.

### BRIEF DESCRIPTION OF THE DRAWING

FIG. 1 is a block diagram setting forth an illustrative audio analyzer and adapter in an audio communication terminal in accordance with a preferred embodiment disclosed herein;

### DETAILED DESCRIPTION OF THE PRESENT EMBODIMENT

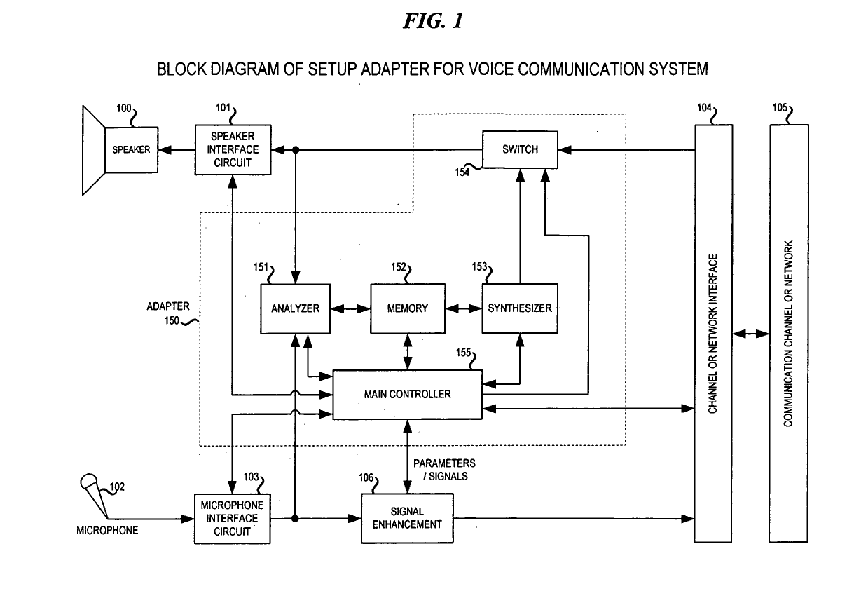

For purposes of the present disclosure, the term “voice communication terminal” is deemed synonymous with any device, handset, or system capable of implementing audio communications, coding, enhancement, or recognition. Refer to FIG. 1, which is a hardware block diagram setting forth an illustrative configuration for an illustrative audio analyzer and adapter in accordance with a preferred embodiment disclosed herein. The configuration of FIG. 1 includes an audio adapter 150 and a speaker 100. Speaker 100, driven by a speaker interface circuit 101, is used to produce sound (acoustic vibration) that is responsive to an output signal from switch 154. Switch 154 selects either a first signal that responsive to a signal received as part of a call via channel interface 104, or a second signal that is emanated from an adapter synthesizer 153. A microphone 102 driven by speaker interface circuit 103 is used to capture sound and generate a responsive signal to be used for transmission as part of a call, and/or to be input to an adapter analyzer 151 as part of the adapter operation. The local device interfaces with a channel or network 105 via a channel interface 104.

The local adapter's analyzer 151, may perform analysis using input from switch 154 or synthesizer 153 (via a memory 152), and/or input from a microphone interface circuit 103. The analyzer uses memory 152, and is controlled by a main controller 155 to which it outputs the analysis outcome such as the time delay between signals, signal sampling rates, and/or signal levels. The main controller 155 controls all the adapter's components. It can activate the signal synthesizer 153, to output desired signal to the line via a switch 154. The main controller 155 can control the speaker and the microphone interface, for example to signal the caller, to connect or to disconnect the caller.

For example, in a preferred embodiment, the controller 155 may be signaled by the channel network interface 104 that call is about to start and ring-tone is needed to be generated or received. Controller 155 may then signals synthesizer 153 to generate ring-tone signal, which is routed via switch to speaker interface circuit 101 to the speaker 100. Alternatively the ring-tone signal may be received from remote generator via the channel 105 and the channel interface 104. This signal is also input to analyzer either by switch 154 or via memory 152. A responsive signal is generated by microphone 102 and is fed via microphone interface circuit 103 to analyzer 151. The analyzer 151 may detect, or receive from controller 155 signals representative of, the audio signal states such as ring-tone pulses and/or silent breaks in between them. The analyzer 151 may pass responsive signals to main controller 155 which may pass control signals to speaker interface circuit 101 and/or to microphone interface circuit 103 to adjust the speaker and/or the microphone setup to improve the audio quality.

Also, based on the ring-tone pulses, the analyzer 151 may measure parameters such as the time the delay between the microphone's output signal and the speaker's input signal, their sampling rates, their relative sampling rate difference, and/or their levels.

Also, the analyzer 151 may measure the background noise characteristic during the silence instances that are between the ring tone pulses. Also shown in FIG. 1 is an optional signal enhancement block 106. Signal enhancement block 106 may be implemented using any of an echo canceller, noise canceller, voice recognition system, or voice compression system. Signal enhancement system 106 may receive and/or transmit signals and/or parameters via controller 155 which may be used for applying signal enhancement and/or voice recognition and/or voice compression to the signal captured by the microphone.

This method and system is aimed to automatically (or manually) adjust the audio device of voice communication terminal, such as personal computer (PC) that is used for hand-free voice over Internet protocol (VoIP) conversation or chat application. PC has multi-purpose audio devices that are needed to be carefully configured to produce high quality audio conversation having minimal distortion by properly adjusting them. It is advantageous to adjust the audio devices before the actual VoIP call starts, and in a way that does not annoy the naive user or is even invisible to him/her. Additionally, such pre-computed parameters representing the acoustic environment and/or the audio device may be useful for subsequent audio enhancement processing.

One preferred embodiment may be performed by transmitting predetermined signals commonly used in telephony such as ring-tone (which may or may not be otherwise necessary for the particular communication system), in order to determine the time delay and/or sampling rate differences between the played reference signal and the corresponding recorded signal. Utilizing such a telephony ring-tone signal for the above purpose is advantageous since its existence at the beginning of the call is naturally expected and/or accepted by the general user, and since it is a narrowband signal that can be extracted in high signal to noise ratio (SNR). Ring-tone like other telephony signals has well defined frequencies, levels, duration and timing which makes it very suitable reference signal for various tests and analyses. During ring-tone, the local audio communication terminal's audio is fully functional, but the remote terminal is not yet connected, and therefore no feedback and artifacts may be sounded, which makes its timing advantageous for performing audio analysis and adaptation. In addition, since ring-tones are typically spaced by silence breaks, two types of synchronized analyses may be performed, i.e. one during the tone pulses and the other during the breaks. Since people tend to listen and remain silent during ring-tone sounded at the beginning of a call, background noise analysis may advantageously be performed during the silence breaks that are between the tone pulses.

Predetermined parameters such as signal time-delay, signal levels, and sampling rates may be useful for subsequent audio enhancement processing such as Acoustic Echo Cancellation and Adaptive Noise Cancellation, for voice activity detectors, for adaptive gain control, and for other systems such as speech coding and speech recognition systems.

The method and system may be useful for many additional communication terminals such as cordless phones, cellular phones and similar devices, Personal Digital Assistant (PDA), various hand free communication terminals and/or handsets such as multi-purpose “smart” headset, etc.

It should, of course, be noted that while the present invention has been described in terms of an illustrative embodiment, other arrangements will be apparent to those of ordinary skills in the art. For example;
1. While in the disclosed embodiment adapter 150 is shown in the FIG. 1 as a separate scheme, in other arrangements this adapter can be incorporated into another device or apparatus including, but not limited, to: a telephone, a speaker phone, a teleconferencing station, a cellular phone, a voice over the Internet (VoIP) phone, a cellular phone, a personal digital assistant (PDA), a laptop or pocket personal computer (PC), or a wireless communication device.
2. While in the disclosed embodiment, separate speaker 100 and microphone 102 are shown, this is for illustrative purposes as, in other arrangements, they can be integrated into a single element or provided as part of a handset or handset-free communications device.
3. While in the disclosed embodiment one speaker 100 and one microphone 102 are shown, in other arrangements there could be no or multiple speakers and/or microphones.
4. While in the disclosed embodiment, speech synthesis and tone generation are utilized, in other applications only one of them may be used.
5. While in the disclosed embodiment, speech synthesis 153 is utilized, in other applications each or any of this function can be performed by another device or system that interfaces directly or indirectly with the system of the disclosed embodiment.
6. While in the disclosed embodiment, user interface 130 is utilized, in other applications user input can be received by another device or system that interfaces directly or indirectly with the system of the disclosed embodiment.
7. While in the disclosed embodiment, audio synthesizer 154 is utilized, in other applications generated tone and/or speech can be received from another device or system that interfaces directly or indirectly with the system of the disclosed embodiment.
8. While in the disclosed embodiment, a ring tone (call-progress tone) is described as an advantageous reference signal, in other applications, other audible tones and/or signals may be used.
9. While in the disclosed embodiment, speech synthesizer 154 is utilized, in other applications text-to-speech can be used with the system of the disclosed embodiment.
10. While in the disclosed embodiment, analyzer 131 is utilized, in other applications tone detection outcome can be received from another device or system that interfaces directly or indirectly with the system of the disclosed embodiment.
11. While in the disclosed embodiment one channel or network 105, is shown, other arrangements will be apparent to those of ordinary skills in the art. For example, the combination of networks, tandem elements, switches, routers, gateways, hubs, and bridges, and/or transmission stations, can be used.
12. While in the disclosed communication channel or network 105 and channel or network interface 104 are described, other arrangements will be apparent to those of ordinary skill in the art. For example, a channel may be implemented via a storage device or system.
13. While in the disclosed embodiment one memory 152 is described, other arrangements will be apparent to those of ordinary skills in the art. For example, more than one memory device can be used, and/or the system can share memory with another device or system.
14. Finally, while the disclosed embodiment utilized discrete devices, these devices can be implemented using one or more appropriately programmed general-purpose processors, or special-purpose integrated circuits, or digital processors, or an analog or hybrid counterpart of any of these devices.

### REFERENCES CITED

### U.S. Patent Documents

U.S. Pat. No. 5,463,618 October 1995 Furukawa et al.
U.S. Pat. No. 5,696,821 December 1997 Urbanski
U.S. Pat. No. 5,721,772 February 1998 Haneda et al.
U.S. Pat. No. 5,732,134 March 1998 Sih
U.S. Pat. No. 5,761,318 June 1998 Shimauchi et al.
U.S. Pat. No. 6,049,606 April 2000 Ding et al.
U.S. Pat. No. 6,185,300 February 2001 Romesburg
U.S. Pat. No. 6,192,126 February 2001 Koski
U.S. Pat. No. 6,563,803 May 2003 Lee
U.S. Pat. No. 6,792,107 September, 2004 Tucker, et al.
U.S. Pat. No. 6,148,078 November, 2000 Romesburg; Eric Douglas
U.S. Pat. No. 7,065,206 June, 2006 Pan; Jianhua
U.S. Pat. No. 5,617,472 April 1997 Yoshida et al.
U.S. Pat. No. 5,680,393 October 1997 Bourmeyster et al.
U.S. Pat. No. 5,687,075 November 1997 Stothers
U.S. Pat. No. 5,691,893 November 1997 Stothers
U.S. Pat. No. 5,768,124 June 1998 Stothers et al.
U.S. Pat. No. 6,108,412 August 2000 Liu et al.

I claim:

1. A method for automatically configuring an audio device upon commencement of establishment of a communications path, the method comprising:
transmitting one or more predetermined reference signals into an acoustic environment, receiving the transmitted signals from the acoustic environment to thereby provide received signals, and
configuring the device by adjusting at least one of a speaker gain of a speaker and a microphone gain of a microphone in response to the received signals.

2. The method of claim 1 wherein the reference signals include at least one of a ring tone signal as used in landline telephony, a dual tone multifrequency (DTMF) tone, and/or other predetermined audio signals that are intended to signal the user at least one of the following (a) as a part of initiating a call, (b) about upcoming call, (c) about incoming call, (d) as a part of creating a call, (e) about phase of waiting for a call, (f) about a specific phase in a call, (g) about call progress and/or (h) about call termination.

3. The method of claim 1 further including computing one or more parameters for subsequent audio processing, and the one or more parameters include a delay between an acoustic signal produced by the speaker in response to the electrical signal being input to the speaker and an electrical signal produced by the microphone in response to a receipt of the acoustic signal generated by the speaker.

4. The method of claim 3 further including computing one or more parameters for
subsequent audio processing, and the one or more parameters include a sampling rate difference or ratio applicable to the electrical signal produced by the microphone as compared with the electrical signal being input to the speaker.

5. The method of claim 1 further including extracting one or more parameters characterizing the acoustic environment upon establishment of a communications path, wherein the parameter extraction is performed by transmitting one or more predetermined reference signals selected from signals that are used in conventional telephony, and/or other predetermined audio signals that are intended to signal the user at least one of the following (a) as a part of initiating a call, (b) about upcoming call, (c) about incoming call, (d) as a part of creating a call, (e) about phase of waiting for a call, (f) about a specific phase in a call, (g) about call progress and/or (h) about call termination.

6. The method of claim 5 wherein the one or more extracted parameters are extracted in response to transmission of at least one reference signal that is used in conjunction with landline telephony, including at least one of a ring tone, a dual tone multifrequency (DTMF) tone, and/or other predetermined audio signals that are intended to signal the user at least one of the following (a) as a part of initiating a call, (b) about upcoming call, (c) about incoming call, (d) as a part of creating a call, (e) about phase of waiting for a call, (f) about a specific phase in a call, (g) about call progress and/or (h) about call termination.

7. The method of claim 5 wherein the one or more extracted parameters are extracted by performing at least one of: (a) synthesizing one or more predetermined reference signals, (b) transmitting an audible signal, (c) receiving an audible signal, (d) analyzing one or more signals including at least one of speech, noise, tones, or dual-tone multi-frequency (DTMF) tones, (e) adjusting an audio amplifier, and (f) inputting extracted parameters to one or more auxiliary systems including at least one of an audio enhancement system, a voice activity detector, a speech coding system, or a speech recognition system.

8. The method of claim 7 wherein the one or more extracted parameters are representative of at least one of background noise, a delay between an audible signal generated by the speaker and a corresponding input signal captured by the microphone, or a signal gain or energy and/or a transmission characteristic from the speaker to the microphone.

9. The method of claim 1 performed using at least one of a telephone, a wireless phone, a voice-over-Internet protocol (VoIP) phone, a computing device, a laptop computer, a pocket personal computer (PC), a personal digital assistant (PDA), a teleconferencing system, or a multi-purpose “smart” headset.

10. The method of claim 1 wherein a first parameter is computed during a transmission of a tone pulse, and a second parameter is computed during a break when a tone pulse is not being transmitted, the method further comprising performing subsequent processing using at least one of an echo canceller, a noise canceller, an audio coding system, a voice activity detector, an adaptive gain controller, or a voice recognition system.

11. A system for automatically configuring an audio device upon commencement of establishment of a communications path, the system comprising:
a transmitter transmitting one or more predetermined reference signals into an acoustic environment,
a receiver for receiving the transmitted signals from the acoustic environment to thereby provide received signals, and
an analyzing mechanism for adjusting at least one of a speaker gain and a microphone gain in response to the received signals.

12. The system of claim 11 wherein the reference signals include at least one of a ring tone signal as used in landline telephony, a dual tone multifrequency (DTMF) tone, and/or other predetermined audio signals that are intended to signal the user at least one of the following (a) as a part of initiating a call, (b) about upcoming call, (c) about incoming call, (d) as a part of creating a call, (e) about phase of waiting for a call, (f) about a specific phase in a call, (g) about call progress and/or (h) about call termination.

13. The system of claim 11 wherein the analyzing mechanism is capable of computing one or more parameters for subsequent audio processing, and the one or more parameters include a delay between an electrical signal produced by the microphone in response to an acoustic input and an acoustic signal produced by the speaker in response to the electrical signal being input to the speaker.

14. The system of claim 13 wherein the analyzing mechanism is capable of computing one or more parameters for subsequent audio processing, and the one or more parameters include a sampling rate difference or ratio applicable to the electrical signal produced by the microphone as compared with the electrical signal being input to the speaker.

15. The system of claim 11 wherein the analyzing mechanism is capable of extracting one or more parameters characterizing the acoustic environment upon establishment of a communications path, wherein the parameter extraction is performed by transmitting one or more predetermined reference signals selected from signals that are used in conventional telephony, and/or other predetermined audio signals that are intended to signal the user at least one of the following (a) as a part of initiating a call, (b) about upcoming call, (c) about incoming call, (d) as a part of creating a call, (e) about phase of waiting for a call, (f) about a specific phase in a call, (g) about call progress and/or (h) about call termination.

16. The system of claim 15 wherein the analyzing mechanism is capable of extracting one or more parameters in response to transmission of at least one reference signal that is used in conjunction with landline telephony, including at least one of a ring tone, a dual tone multifrequency (DTMF) tone, and/or other predetermined audio signals that are intended to signal the user at least one of the following (a) as a part of initiating a call, (b) about upcoming call, (c) about incoming call, (d) as a part of creating a call, (e) about phase of waiting for a call, (f) about a specific phase in a call, (g) about call progress and/or (h) about call termination.

17. The system of claim 15 wherein the analyzing mechanism is capable of extracting one or more parameters by performing at least one of: (a) synthesizing one or more predetermined reference signals, (b) transmitting an audible signal, (c) receiving an audible signal, (d) analyzing one or more signals including at least one of speech, noise, tones, or dual-tone multi-frequency (DTMF) tones, (e) adjusting an audio amplifier, and (f) inputting extracted parameters to one or more auxiliary systems including at least one of an audio enhancement system, a voice activity detector, a speech coding system, or a speech recognition system.

18. The system of claim 17 wherein the one or more extracted parameters are representative of at least one of background noise, a delay between an audible signal generated by the speaker and a corresponding input signal captured by the microphone, or a signal gain or energy and/or a transmission characteristic from the speaker to the microphone.

19. The system of claim 11 wherein the analyzing mechanism, the transmitter, and the receiver are implemented using at least one of a telephone, a wireless phone, a voice-over-Internet protocol (VoIP) phone, a computing device, a laptop computer, a pocket personal computer (PC), a personal digital assistant (PDA), a teleconferencing system, or a multi-purpose “smart” headset

20. The system of claim 11 wherein the analyzing mechanism is capable of computing a first parameter during a transmission of a tone pulse, and capable of computing a second parameter during a break when a tone pulse is not being transmitted, the analyzing mechanism performing subsequent processing using at least one of an echo canceller, a noise canceller, an audio coding system, a voice activity detector, an adaptive gain controller, or a voice recognition system.
